(19) United States
(12) Patent Application Publication
(10) Pub. No.: US 2018/0293023 A1
(43) Pub. Date: Oct. 11, 2018

(54) STORAGE RESOURCE MANAGEMENT EMPLOYING LATENCY ANALYTICS

(71) Applicant: Nutanix, Inc., San Jose, CA (US)

(72) Inventors: Vanish Talwar, Campbell, CA (US); Gokul Nadathur, Fremont, CA (US)

(21) Appl. No.: 15/481,360

(22) Filed: Apr. 6, 2017

(51) Int. Cl. G06F 3/06

(52) U.S. Cl. CPC G06F 3/0659; G06F 3/067; G06F 3/0631; G06F 3/0611

(57) ABSTRACT

Performance of a computing system is improved by identifying storage clients that generate relatively large workloads and mitigating overall impact of the identified storage clients. Latency is monitored for different write and read I/O request block sizes. When latency for any request bock size increases above a predefined threshold for the request block size, diagnostics are performed to identify a storage client that generated an excessive workload or workloads comprising large blocks that caused the increased latency. A mitigation action can then be performed.

### BACKGROUND

### Field

This non-provisional U.S. patent application relates generally to storage resource management in computing systems and more specifically to those employing latency analytics.

### Description of Related Art

Certain computing architectures include a set of computing systems coupled through a data network to a set of storage systems. The computing systems provide computation resources and are typically configured to execute applications within a collection of virtual machines. The storage systems are typically configured to present storage resources to the virtual machines.

A given virtual machine can access a storage resource residing on a storage system. Under certain conditions, access to the storage resource may exhibit increasing latency, which can lead to performance degradation of the virtual machine. For example, in a scenario with multiple virtual machines or other storage clients concurrently accessing the storage system, response latency for the storage system may increase over time as various internal queues back up and the storage system becomes increasingly overloaded and/or there is increasing contention for shared storage resources.

Conventional storage system management techniques commonly fail to address performance degradation correlated with increasing latency. What is needed therefore is an improved technique for managing storage systems.

### SUMMARY

According to various embodiments, a method comprising: detecting, by a storage resource manager, a latency change event for a first input/output (I/O) block size of read I/O requests or write I/O requests targeting storage resources residing within a storage controller, wherein detecting comprises: measuring that a latency for a first block size of read I/O requests exceeds a nominal read latency for the first block size or a latency for the first block size of write I/O requests exceeds a nominal write latency for the first block size; recording a first set of input/output operations per second (IOPS) values in response to the latency exceeding the nominal latency; and measuring that the latency exceeds a significant latency threshold; recording, by the storage resource manager, a block size presence set and a second set of IOPS values in response to detecting the latency change event, wherein the block size presence set is a count of requests for different read I/O request block sizes and write I/O request block sizes accumulated during a measurement time period; generating, by the storage resource manager, a list of cost differences using the block size presence set, the first set of IOPS values, and the second set of IOPS values, wherein a cost difference for individual storage resources residing within the storage controller is calculated and added to the list of cost differences; generating, by the storage resource manager, a sorted list of cost differences by sorting the list of cost differences in decreasing order of cost difference; selecting, by the storage resource manager, a storage resource bully from the sorted list of cost differences; directing, by the storage resource manager, a mitigation action in response to selecting the storage resource bully.

According to various further embodiments, an apparatus comprising: a processing unit in communication with a storage controller, the processing unit configured to: detect a latency change event for a first input/output (I/O) block size of read I/O requests or write I/O requests targeting storage resources residing within the storage controller, wherein to detect the latency change event, the processing unit is configured to: measure that a latency for a first block size of read I/O requests exceeds a nominal read latency for the first block size or a latency for the first block size of write I/O requests exceeds a nominal write latency for the first block size; record a first set of input/output operations per second (IOPS) values in response to the latency exceeding the nominal latency; and measure that the latency exceeds a significant latency threshold; record a block size presence set and a second set of IOPS values in response to detecting the latency change event, wherein the block size presence set is a count of requests for different read I/O request block sizes and write I/O request block sizes accumulated during a measurement time period; generate a list of cost differences using the block size presence set, the first set of IOPS values, and the second set of IOPS values, wherein a cost difference for individual storage resources residing within the storage controller is calculated and added to the list of cost differences; generate a sorted list of cost differences by sorting the list of cost differences in decreasing order of cost difference; select a storage resource bully from the sorted list of cost differences; direct a mitigation action in response to selecting the storage resource bully.

According to various still further embodiments, a method comprising: detecting, by a storage resource manager, a latency change event for a first input/output (I/O) block size of read I/O requests or write I/O requests targeting storage resources residing within a storage controller, wherein detecting comprises: measuring that a latency for a first block size of read I/O requests exceeds a nominal read latency for the first block size or a latency for the first block size of write I/O requests exceeds a nominal write latency for the first block size; recording a first set of input/output operations per second (IOPS) values in response to the latency exceeding the nominal latency; and measuring that the latency exceeds a significant latency threshold; recording, by the storage resource manager, a block size presence set and a second set of IOPS values in response to detecting the latency change event, wherein the block size presence set is a count of requests for different read I/O request block sizes and write I/O request block sizes accumulated during a measurement time period; generating, by the storage resource manager, a list of cost differences using the block size presence set, the first set of IOPS values, and the second set of IOPS values, wherein a cost difference for individual storage resources residing within the storage controller is calculated and added to the list of cost differences; generating, by the storage resource manager, a sorted list of cost differences by sorting the list of cost differences in decreasing order of cost difference; selecting, by the storage resource manager, a storage client bully from the sorted list of cost differences; and directing, by the storage resource manager, a mitigation action in response to selecting the storage client bully.

According to various yet still further embodiments, an apparatus comprising: a processing unit in communication with a storage controller, the processing unit configured to: detect a latency change event for a first input/output (I/O) block size of read I/O requests or write I/O requests targeting storage resources residing within the storage controller, wherein to detect the latency change event, the processing unit is configured to: measure that a latency for a first block size of read I/O requests exceeds a nominal read latency for the first block size or a latency for the first block size of write I/O requests exceeds a nominal write latency for the first block size; record a first set of input/output operations per second (IOPS) values in response to the latency exceeding the nominal latency; and measure that the latency exceeds a significant latency threshold; record a block size presence set and a second set of IOPS values in response to detecting the latency change event, wherein the block size presence set is a count of requests for different read I/O request block sizes and write I/O request block sizes accumulated during a measurement time period; generate a list of cost differences using the block size presence set, the first set of IOPS values, and the second set of IOPS values, wherein a cost difference for individual storage resources residing within the storage controller is calculated and added to the list of cost differences; generate a sorted list of cost differences by sorting the list of cost differences in decreasing order of cost difference; select a storage client bully from the sorted list of cost differences; and direct a mitigation action in response to selecting the storage client bully.

### BRIEF DESCRIPTION OF THE DRAWINGS

FIG. 1 is a block diagram of a portion of a computing system operating environment in which various embodiments can be practiced.

FIG. 2 is a block diagram of an exemplary storage system in which various embodiments can be practiced.

FIG. 3 illustrates an exemplary graph of input/output (I/O) operations per second for four-kilobyte (4K) read I/O requests and latency for the 4K read I/O requests as a function of time, according to some embodiments.

FIG. 4 illustrates an exemplary graph of a latency change event, according to some embodiments.

FIG. 5 is a flow chart of a method for identifying a storage client bully using latency values, according to some embodiments.

### DETAILED DESCRIPTION

In typical system architectures, computing systems generate a workload (i.e., read and/or write requests per second) that is serviced by a storage controller within a storage system. Multiple storage clients (e.g., virtual machines, software applications, etc.) can contribute to the workload of the storage system, and certain storage clients can generate large workloads, potentially leading to performance degradation of other storage clients.

A storage client generating a relatively large portion of a storage system workload is referred to herein as a “noisy neighbor” with respect to other storage clients. A noisy neighbor generating a large workload that causes other storage clients to potentially suffer performance degradation is referred to herein as a storage client bully, virtual machine bully, or simply bully. A bully can individually increase storage system workload and cause an increase in latency for other storage clients. A bully can cause other storage clients to experience performance degradation by overloading a common storage system. A bully can also refer to a storage resource being accessed intensely, thereby causing access to other storage resources to suffer performance degradation. In the context of the present disclosure, a storage resource can include, without limitation, a block storage container such as a storage logical unit number (LUN), an arbitrary set of individual storage blocks, a datastore such as a VMware ESX™ datastore, one or more storage volumes, a virtual disk (e.g., a VMware™ vDisk), a stored object, or a combination thereof. A measured increase in latency is used by techniques described herein as an indicator of potential performance degradation and a source of diagnostic data for identifying bullies. In various embodiments, a workload cost is calculated and attributed to different storage clients. The storage clients can be ranked (sorted) according to the cost of their workloads and one or more storage client bullies can be identified. Similarly, storage resources can be ranked according to the cost of their workloads. A rank for a given storage resource can be used to identify the storage resource as a bully and/or identify a client bully that is configured to access the storage resource.

System operation is improved by identifying storage client bullies, and performing mitigation operations to reduce the overall cost of a given workload at a given storage system. A relative cost is defined for different read I/O request block sizes and different write I/O request block sizes, and the relative cost is used to rank storage clients according to attributed cost contribution to a given workload. Storage clients generating the highest workload costs are identified as targets for potential mitigation. Mitigation operations include, without limitation, activating a system cache to cache data requests associated with a specified storage client (e.g., a storage client bully), activating rate limiting on a specified storage client (e.g., a storage client bully), and migrating a storage resource (e.g., a LUN, a vDisk, or a vDisk stored within a LUN) targeted by the storage client to a different storage system or storage controller. The relative cost of write and read I/O requests, and techniques for rating storage clients according to workload cost are discussed below.

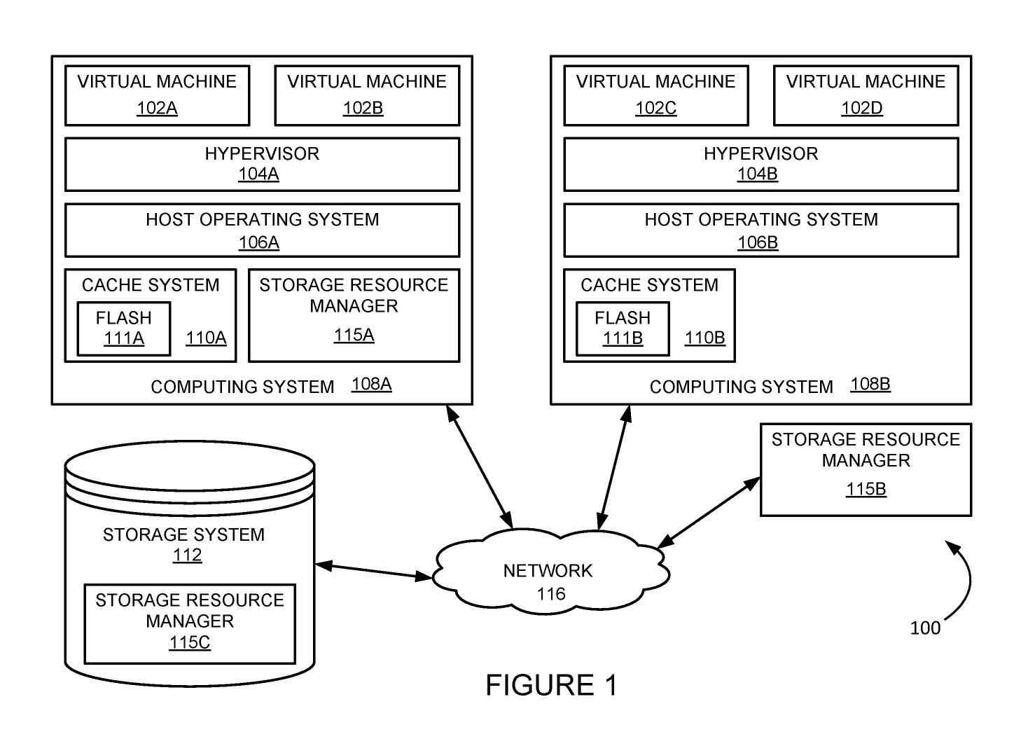

FIG. 1 is a block diagram of a portion of an environment 100 in which various embodiments can be practiced. Referring first to computing system 108A on the left, the environment 100 comprises one or more virtual machines 102 (denoted 102A & 102B in the figure, and wherein each virtual machine can itself be considered an application) executed by a hypervisor 104A. The hypervisor 104A is executed by a host operating system 106A (which may itself include the hypervisor 104A) or may execute in place of the host operating system 106A. The host operating system 106A resides on the physical computing system 108A having a cache system 110A. The cache system 110A includes operating logic to cache data within a local memory). The local memory is a faster, more expensive memory such as Dynamic Random Access Memory (DRAM) or persistent devices such as flash memory 111A. The environment 100 can include multiple computing systems 108, as is indicated in the figure by computing system 108A and computing system 108B. Each of computing system 108A and 108B is configured to communicate across a network 116 with a storage system 112 to store data. Network 116 is any known communications network including a local area network, a wide area network, a proprietary network or the Internet. The storage system 112 is a slower memory, such as a Solid State Drive (SSD) or hard disk. The environment 100 can include multiple storage systems 112. Examples of storage system 112 include, but are not limited to, a storage area network (SAN), a local disk, a shared serial attached “small computer system interface (SCSI)” (SAS) box, a network file system (NFS), a network attached storage (NAS), an internet SCSI (iSCSI) storage system, and a Fibre Channel storage system.

Referring to either of computing system 108A or 108B, when a virtual machine 102 generates a read command or a write command, the application sends the generated command to the host operating system 106. The virtual machine 102 includes, in the generated command, an instruction to read or write a data record at a specified location in the storage system 112. When activated, cache system 110 receives the sent command and caches the data record and the specified storage system memory location. As understood by one of skill in the art, in a write-through cache system, the generated write commands are simultaneously sent to the storage system 112. Conversely, in a write-back cache system, the generated write commands are subsequently sent to the storage system 112 typically using what is referred to herein as a destager.

In some embodiments of the present approach, and as would be understood by one of skill in the art in light of the teachings herein, the environment 100 of FIG. 1 can be further simplified to being a computing system running an operating system running one or more applications that communicate directly or indirectly with the storage system 112.

As stated above, cache system 110 includes various cache resources. In particular and as shown in the figure, cache system 110 includes a flash memory resource 111 (e.g., 111A and 111B in the figure) for storing cached data records. Further, cache system 110 also includes network resources for communicating across network 116.

Such cache resources are used by cache system 110 to facilitate normal cache operations. For example, virtual machine 102A may generate a read command for a data record stored in storage system 112. As has been explained and as understood by one of skill in the art, the data record is received by cache system 110A. Cache system 110A may determine that the data record to be read is not in flash memory 111A (known as a “cache miss”) and therefore issue a read command across network 116 to storage system 112. Storage system 112 reads the requested data record and returns it as a response communicated back across network 116 to cache system 110A. Cache system 110A then returns the read data record to virtual machine 102A and also writes or stores it in flash memory 111A (in what is referred to herein as a “false write” because it is a write to cache memory initiated by a generated read command versus a write to cache memory initiated by a generated write command which is sometimes referred to herein as a “true write” to differentiate it from a false write).

Having now stored the data record in flash memory 111A, cache system 110A can, following typical cache operations, now provide that data record in a more expeditious manner for a subsequent read of that data record. For example, should virtual machine 102A, or virtual machine 102B for that matter, generate another read command for that same data record, cache system 110A can merely read that data record from flash memory 111A and return it to the requesting virtual machine rather than having to take the time to issue a read across network 116 to storage system 112, which is known to typically take longer than simply reading from local flash memory.

Likewise, as would be understood by one of skill in the art in light of the teachings herein, virtual machine 102A can generate a write command for a data record stored in storage system 112 which write command can result in cache system 110A writing or storing the data record in flash memory 111A and in storage system 112 using either a write-through or write-back cache approach.

Still further, in addition to reading from and/or writing to flash memory 111A, in some embodiments cache system 110A can also read from and/or write to flash memory 111B and, likewise, cache system 110E can read from and/or write to flash memory 111B as well as flash memory 111A in what is referred to herein as a distributed cache memory system. Of course, such operations require communicating across network 116 because these components are part of physically separate computing systems, namely computing system 108A and 108B. In certain embodiments, cache system 110 can be optionally activated or deactivated. For example, cache system 110 can be activated to cache I/O requests generated by a specified virtual machine 102, or I/O requests targeting a specific storage resource within the storage system 112. When activated, cache system 110 can serve to mitigate latency and performance impacts of one or more storage client bullies or one or more storage resources. In other embodiments, cache system 110 is not included within a computing system 108.

The storage system 112 is configured to receive read and write I/O requests, which are parsed and directed to storage media modules (e.g., magnetic hard disk drives, solid-state drives, flash storage modules, phase-change storage devices, and the like). While no one storage media module is necessarily designed to service I/O requests at an overall throughput level of storage system 112, a collection of storage media modules can be configured to generally provide the required overall throughput. However, in certain scenarios, I/O requests from multiple storage clients can disproportionately target one or a few storage media modules, leading to a bottleneck and a significant increase in overall system latency. Similarly, I/O requests can disproportionately target different system resources, such as controller processors, I/O ports, and internal channels, causing interference among the I/O requests. Such interference among I/O requests contending for the same system resource can lead to degraded performance and elevated latency. In one embodiment, the storage subsystem 112 presents storage blocks residing within the storage media modules as one or more LUNs, with different LUNs presenting a range of numbered storage blocks. A given LUN can be partitioned to include one or more different virtual disks (vDisks) or other storage structures. As defined herein, a given LUN can be considered a storage resource, and a given vDisk residing within the LUN can be considered a separate storage resource.

In one embodiment, multiple vDisks are assigned to reside within a first LUN that is managed by a first storage controller. Furthermore, the LUN and the vDisks are configured to reside within the same set of storage media modules. In a scenario where a storage client bully begins intensively accessing one of the vDisks in the LUN, other vDisks in the LUN can potentially suffer performance degradation because the different vDisks share the same storage media modules providing physical storage for the LUN. In certain cases, other unrelated LUNs residing on the same storage media modules can also suffer performance degradation. Similarly, otherwise unrelated LUNs sharing a common storage controller can suffer performance degradation if the storage client bully creates a throughput bottleneck or stresses overall performance of the common storage controller.

In one embodiment, the storage subsystem 112 is configured to accumulate usage statistics, including read and write statistics for different block sizes for specified storage resources, latency statistics for different block sizes of the specified storage resources, and the like. For example, the storage subsystem 112 can be configured to accumulate detailed and separate usage statistics for different LUNs, vDisks, or other types of storage resource residing therein. In one embodiment, a virtual machine run time system is configured to similarly track access statistics generated by virtual machines 102 executing within the run time system.

In one embodiment, a storage resource manager 115A is configured to generate latency values, performance utilization values, or a combination thereof for one or more storage systems 112 and perform system management actions according to the latency values. The resource manager 115A can be implemented in a variety of ways known to those skilled in the art including, but not limited to, as a software module executing within computing system 108A. The software module may execute within an application space for host operating system 106A, a kernel space for host operating system 106A, or a combination thereof. Similarly, storage resource manager 115A may instead execute as an application within a virtual machine 102. In another embodiment, storage resource manager 115A is replaced with storage resource manager 115B, configured to execute in a computing system that is independent of computing systems 108A and 108B. In yet another embodiment, storage resource manager 115A is replaced with a storage resource manager 115C configured to execute within a storage system 112.

In one embodiment, a given storage resource manager 115 includes three sub-modules. A first sub-module is a data collection system for collecting IOPS, workload profile, and latency data; a second sub-module is a latency change and diagnosis system; and, a third sub-module is a mitigation execution system configured to direct or perform mitigation actions such as migration to overcome an identified cause of a latency increase. The first (data collection) sub-module is configured to provide raw usage statistics data for usage of the storage system. For example, the raw usage statistics data can include input/output operations per second (IOPS) performed for read and write I/O request block sizes and workload profiles (accumulated I/O request block size distributions). In one embodiment, a portion of the first sub-module is configured to execute within storage system 112 to collect raw usage statistics related to storage resource usage, and a second portion of the first sub-module is configured to execute within computing systems 108 to collect raw usage statistics related to virtual machine resource usage. In one embodiment, the raw usage statistics include latency values for different read I/O request block sizes and different write I/O request block sizes of the storage system 112. The second (latency change and diagnosis) sub-module is configured to detect a latency change event, as described herein, and upon detecting the latency change event, the second sub-module performs diagnosis operations to identify a bully storage resource and/or bully storage client responsible for causing the latency change event and related increase in latency. In one embodiment, the second sub-module is implemented to execute within a computing system 108 (within storage resource manager 115A), an independent computing system (within storage resource manager 115B) or within storage system 112 (within storage resource manager 115C). The third (mitigation execution) sub-module is configured to receive latency value and/or detection output results of the second sub-module, and respond to the output results by directing or performing a system management action as described further elsewhere herein.

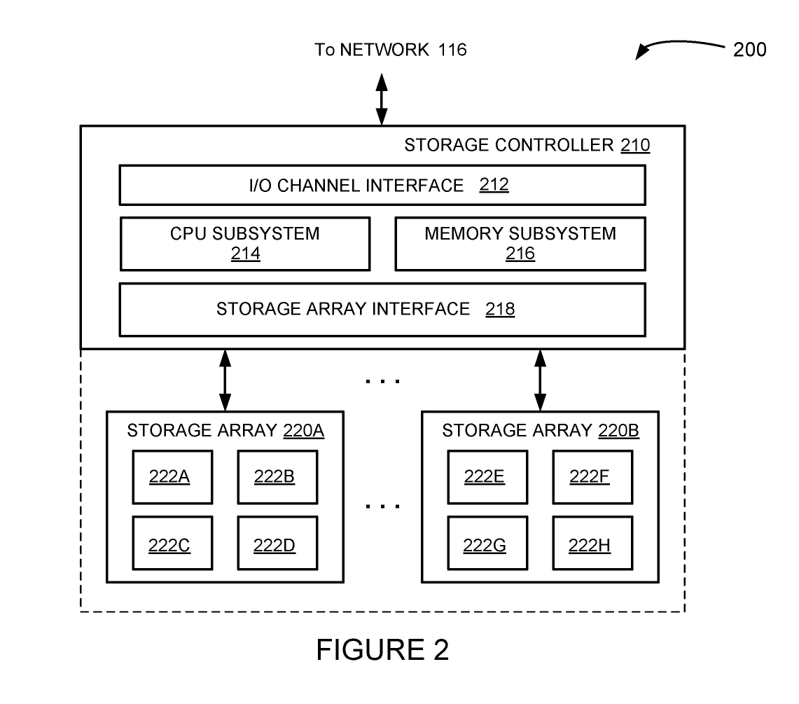

FIG. 2 is a block diagram of an exemplary storage system 200 in which various embodiments can be practiced. In one embodiment, storage system 112 of FIG. 1 includes at least one instance of storage system 200. As shown, storage system 200 comprises a storage controller 210 and one or more storage array 220 (e.g., storage arrays 220A and 220B). Storage controller 210 is configured to provide read and write access to storage resources 222 residing within a storage array 220. In one embodiment, storage controller 210 includes an input/output (I/O) channel interface 212, a central processing unit (CPU) subsystem 214, a memory subsystem 216, and a storage array interface 218. In certain embodiments, storage controller 210 is configured to include one or more storage arrays 220 within an integrated system. In other embodiments, storage arrays 220 are discrete systems coupled to storage controller 210.

In one embodiment, I/O channel interface 212 is configured to communicate with network 116. CPU subsystem 214 includes one or more processor cores, each configured to execute instructions for system operation such as performing read and write access requests to storage arrays 220. A memory subsystem 216 is coupled to CPU subsystem 214 and configured to store data and programming instructions. In certain embodiments, memory subsystem 216 is coupled to I/O channel interface 212 and storage array interface 218, and configured to store data in transit between a storage array 220 and network 116. Storage array interface 218 is configured to provide media-specific interfaces (e.g., SAS, SATA, etc.) to storage arrays 220.

Storage controller 210 accumulates raw usage statistics data and transmits the raw usage statistics data to a storage resource manager, such as storage resource manager 115A, 115B, or 115C of FIG. 1. In particular, the raw usage statistics data can include independent IOPS values for different read I/O request block sizes and different write I/O request block sizes. A given mix of different read I/O request block sizes and different write I/O request block sizes accumulated during a measurement time period characterizes a workload presented to storage controller 210. Furthermore, the storage resource manager processes the raw usage statistics data to generate a workload profile for the storage controller. A performance profile for storage controller 210 is generated (e.g., by the storage resource manager) using peak IOPS values calculated using the raw usage statistics data. In one embodiment, such a performance profile is generated as described in co-pending patent application Ser. No. 15/451,013 (“the '013 application”) filed Mar. 6, 2017, and entitled “Storage Resource Management Employing Performance Analytics”, which is commonly owned by the applicant of the present application and is incorporated by reference herein in its entirety.

In one embodiment, the workload profile includes aggregated access requests generated by a collection of one or more storage clients directing requests to various storage resources 222 residing within storage controller 210. Exemplary storage clients include, without limitation, virtual machines 102. As the number of storage clients increases and the number of requests from the storage clients increases, the workload for storage controller 210 can increase beyond the ability of storage controller 210 to service the workload, which is an overload condition that results in performance degradation that can impact multiple storage clients. In certain scenarios, an average workload does not generally create an overload condition; however, a workload increase from one or more storage client bullies (e.g., noisy neighbors) create transient increases in workload or request interference, resulting in latency increases and/or performance degradation for other storage clients. In certain settings where different virtual machines 102 are configured to share a computing system 108 and/or a storage system 112 one virtual machine 102 that is a noisy neighbor can become a storage client bully and degrade performance in most or all of the other virtual machines 102.

System operation is improved by relocating storage resources among different instances of storage controller 210 and/or storage system 200. A storage resource that exhibits excessive usage at a source storage controller can be moved to a destination storage controller to reduce latency at the source storage controller while not overloading the destination storage controller.

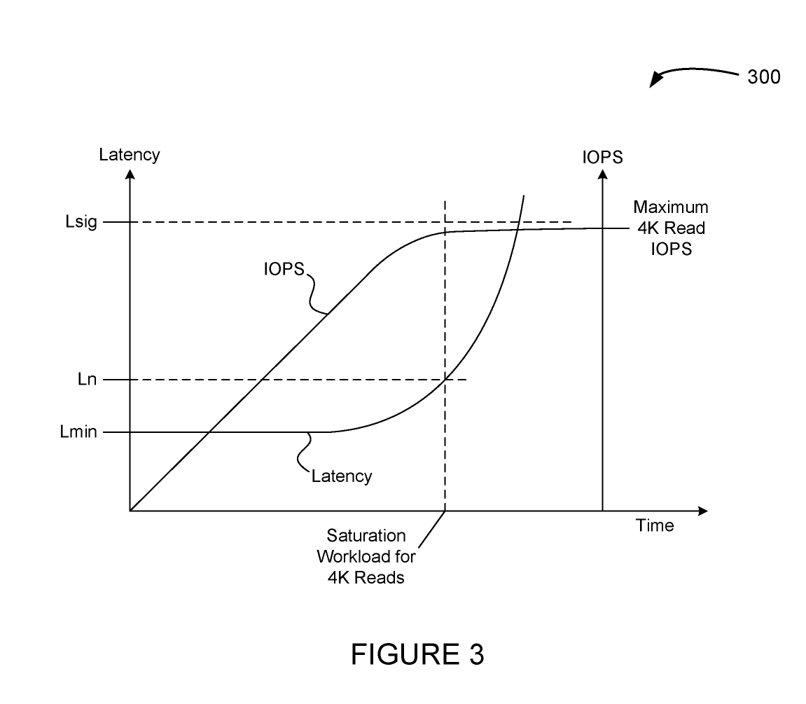

FIG. 3 illustrates an exemplary graph 300 of IOPS for 4K read I/O requests and latency for the 4K read I/O requests as a function of time, according to some embodiments. In the context of graph 300, only 4K read I/O requests are presented as workload to a given storage controller.

In the exemplary graph 300, workload increases over time, and IOPS initially increases and tracks the workload. However, at a saturation workload the storage controller is servicing requests at the highest possible sustained rate for the storage system (saturated). At this point, the storage controller is operating at a peak IOPS value. Storage controller saturation is evident as a flattening of each plot of IOPS, as shown. Certain types of storage media, such as flash memory, have longer write times compared to read times. Consequently, the storage controller may have a lower peak IOPS value for writes (not shown) compared to a peak IOPS value for reads of the same size.

A nominal latency (Ln) for 4K read I/O requests is defined as the latency of 4K read I/O requests at the saturation workload for 4K read I/O requests. A minimum latency (Lmin), as illustrated in FIG. 3, is defined as a minimum latency for 4K read I/O requests for the storage controller, and a significant latency threshold (Lsig) is defined as the product of a threshold multiplier and the nominal latency. In one embodiment, the threshold multiplier is equal to three and the significant latency threshold is defined as three times the nominal latency.

In general, a given storage controller will exhibit a repeatable saturation load, peak IOPS value, and nominal latency for different read I/O and write I/O request block sizes. Furthermore, a performance profile for the storage controller includes independent peak IOPS values, nominal latency values, and significant latency thresholds for different read I/O request block sizes and different write I/O request block sizes.

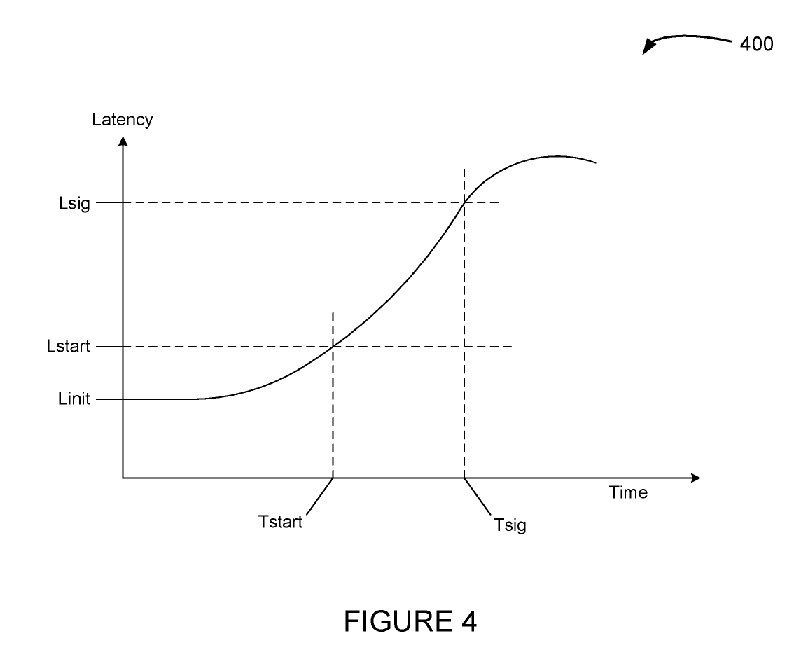

In various embodiments, a change in latency for any different write or read I/O request block size is detected and used to identify one or more potential bullies. Detecting a change in latency is discussed with respect to FIG. 4.

FIG. 4 illustrates an exemplary graph 400 of a latency change event, according to some embodiments. Latency depicted in graph 400 is for one request bock size of either write or read I/O requests (e.g., only 4K reads) targeting a given storage controller, such as storage controller 210. In general, a latency change event is detected when latency increases above a starting latency threshold and further increases to a significant latency threshold. In one embodiment, a latency change period is defined as a time period between a time when latency increases above the starting latency threshold and a time when latency subsequently increases above the significant latency threshold. In one embodiment, diagnosis techniques for identifying storage client bullies and/or storage resource bullies are performed on information comprising the raw usage statistics (e.g., latency information) measured for the latency change period. The latency change event indicates that a storage client bully is active, or alternatively that a storage resource bully is the target of significant request traffic. Upon detecting the latency change event, the bully can be diagnosed and mitigation actions can be taken.

In this example, latency is shown increasing from a relatively low initial latency (Linit), and passing through a starting latency threshold (Lstart) at a corresponding start time Tstart. In one embodiment, the starting latency threshold is equal to the nominal latency, discussed with respect to FIG. 3. A monitoring state is initiated when latency increases above the starting latency threshold. At Tstart, IOPS values for different write and read I/O request block sizes are recorded (Is tart values). In the present example, latency is shown increasing above the significant latency threshold (Lsig) at a corresponding significant threshold time Tsig, thereby indicating a latency change event. In one embodiment, the latency change period is defined as the time period between Tstart and Tsig. A block size presence set is periodically recorded according to a given measurement time period (e.g., every twenty seconds). While latency is shown exceeding the significant latency threshold in this example, in other scenarios the latency can decrease and even drop below the starting latency threshold, depending on storage client workload.

In one embodiment, a latency change event is detected and a corresponding latency change period is identified when latency rises above the starting latency threshold and further rises above the significant latency threshold for any read I/O request block size or any write I/O request block size. For example, if nominal latency for 4K read I/O requests is 1.0 ms (Lstart=1.0 ms), the threshold multiplier is 3.0 (Lsig=3.0 ms), and latency for 4K read I/O requests surpasses 3.0 ms, then a latency change event is detected, regardless of other latencies of other read/write I/O request block sizes. Furthermore, if nominal latency for 16K read I/O requests is, for example, 2.0 ms (Lsig=6.0 ms), and latency for 16K read I/O requests surpasses 6.0 ms, then a latency change event is detected regardless of other latencies.

Upon detecting a latency change (T=Tsig), a block size presence set is recorded for Tsig. The block size presence set is a data object (e.g., data structure, data file) that includes write and read I/O request counts for different request block sizes received within a most recent measurement time period. Furthermore, IOPS values (Isig values) for different write and read I/O request block sizes are recorded at Tsig. In one embodiment, diagnostics are performed to quantify system cost associated with the latency change and identify sources of the latency change (e.g., increased traffic targeting a storage resource, and/or increased traffic generated by a virtual machine).

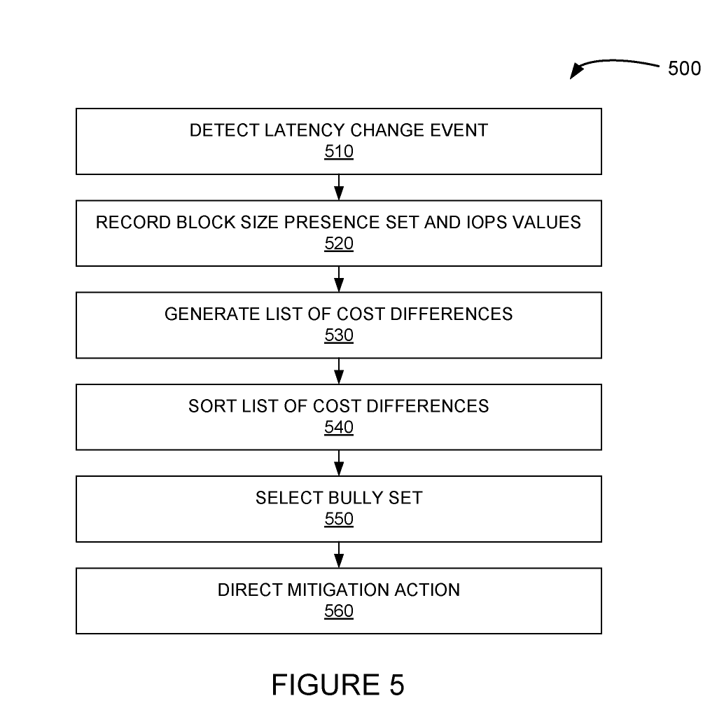

FIG. 5 is a flow chart of a method 500 for identifying a storage client bully and/or a storage resource bully using latency values, according to some embodiments. Although method 500 is described in conjunction with the systems of FIGS. 1 and 2, any computation system that performs method 500 is within the scope and spirit of embodiments of the techniques disclosed herein. In one embodiment, a storage resource manager, such as storage resource manager 115A or 115B of FIG. 1 is configured to perform method 500. Programming instructions for performing method 500 are stored in a non-transitory computer readable storage medium and executed by a processing unit. In one embodiment, the programming instructions comprise a computer program product.

In one embodiment, a performance profile for a given storage system/storage controller is generated to include per-block size cost values for different write and read I/O request block sizes (request sizes). The cost values are calculated to quantify storage controller effort associated with servicing write I/O requests and read I/O requests of different block sizes. System effort is captured in proportion to peak IOPS values for the system. The cost values can be calculated as ratios or normalized values. Furthermore, the cost values can be calculated prior to the storage resource manager performing method 500. In one embodiment, a cost value for a given write or read block size is calculated as a ratio of a sum of peak IOPS values taken over different block sizes for the request type divided by a peak IOPS value for the request type (write or read) and block size.

In one exemplary embodiment, EQUATION 1 calculates a block size read cost value E_{rb} for a block size b and EQUATION 2 calculates a block size write cost value E_{Wb} for block size b. The expression ∀b, i∈{4K . . . 2M} indicates that block size b and index variable i can be assigned values from a set “4K . . . 2M” of potential values. In a practical implementation, such values for b and i may be implemented as enumerated values that represent block size rather than literal values ranging from four thousand to two million. The terms rmaxᵢ and rmax_{b} refer to a peak IOPS value for reads of block size i and b, respectively. Similarly, the terms wmaxᵢ and wmax_{b} refer to peak IOPS values for writes of block size i and b, respectively.

$$\begin{matrix}{E}_{rb} = \frac{{\sum }_{i = 4 K}^{2 M} {rmax}_{i}}{{rmax}_{b}} , ∀ b , i ∈ \{ 4 K … 2 M \} & ( 1 ) \\ {E}_{wb} = \frac{{\sum }_{i = 4 K}^{2 M} {wmax}_{i}}{{wmax}_{b}} , ∀ b , i ∈ \{ 4 K … 2 M \} & ( 2 )\end{matrix}$$

EQUATION 1 calculates block size read cost E_{rb} for a specified block size b as a ratio of a sum of peak IOPS values rmaxᵢ for different read block sizes i divided by a peak IOPS value rmax_{b} for reads of the specified block size b. EQUATION 2 calculates block size write cost E_{wb} for a specified block size b as a ratio of a sum of peak IOPS values wmaxᵢ for different write block sizes i divided by a peak IOPS value wmax_{b} for writes of the specified block size b.

As disclosed herein, identifying a storage client bully involves performing two diagnostic steps. The first diagnostic step identifies a list of storage resource bullies. The second diagnostic step operates on the list of identified storage resource bullies to identify storage client bullies. More specifically, the first diagnostic step identifies a storage resource within a storage controller as a potential bully. When a particular storage resource is the target of a relatively costly workload, that storage resource can be identified as a bully among other storage resources because requests targeting the storage resource (bully) can detrimentally impact performance of the other storage resources on the same storage controller. In support of this goal, latencies are measured for the storage controller to detect a latency increase, and costs are calculated for different storage resources on the storage controller to identify a bully. In one embodiment, cost differences are calculated for read and/or write I/O operations at the storage controller, for operations performed between time Tstart and Tsig for block sizes in a block size presence set P_{sig} for the controller; the block size presence set P_{sig} being recorded for time Tsig. A sorted list of block size cost differences is generated by sorting cost differences associated with different block sizes (e.g., in decreasing order of cost). A set of bully block sizes (for reads and writes) B^{r,w} is identified as block sizes having positive cost differences. In one embodiment, the set of read block sizes and write block sizes includes only those read/write block sizes in a block size presence set P_{sig} recorded for time Tsig, as described herein.

In one embodiment, bully storage resources residing at the storage controller are then identified based on the set of bully block sizes B^{r,w} and block size presence sets for the storage controller and individual storage resources residing at the storage controller. Identifying the bully storage resources comprises identifying candidate bully storage resources and selecting from the candidate bully storage resources those with positive cost increases to be bully storage resources. A given storage resource S is identified as a candidate bully storage resource when a block size presence set for the storage resource P_{sig}(s) includes at least one read block size or at least one write block size identified as a bully block size B^{r,w}. In other words, a given storage resource S is identified as a candidate bully storage resource when either P_{sig}(s)∩B^{r} is not null or P_{sig}(s)∩B^{w} is not null.

A cost difference ΔC (e.g., cost increase) for read IOPS of a block size b for a given storage resource S residing within a given storage controller is indicated as ΔC_{b}^{r}(S) and calculated according to EQUATION 3. This cost difference is calculated by multiplying a difference between a read IOPS value (l_{sig}^{r}) recorded at Tsig and a read IOPS value (Iₛₜₐᵣₜ^{r}) recorded at Tstart by a block size read cost E_{rb}. Similarly, a cost difference (e.g., cost increase) for write IOPS of a block size b is indicated as ΔC_{b}^{w}(s) and calculated according to EQUATION 4.

ΔC_{b}^{r}(S)=(l_{sig}^{r}(S)−lₛₜₐᵣₜ^{r}(S))*E_{rb} (3)

ΔC_{b}^{w}(S)=(l_{sig}^{w}(S)−Iₛₜₐᵣₜ^{w}(S))*E_{wb} (4)

ΔC(S)=(Σ_{b}ΔC_{b}^{r}(S))+(Σ_{b}ΔC_{b}^{w}(S)) (5)

In EQUATION 5, an overall increase in cost is calculated for a storage resource S to include a total cost increase for read I/O requests for block sizes of different block sizes b in a set of read block sizes, and write I/O requests for block sizes b in the set of write block sizes. In one embodiment, EQUATIONS 3-5 calculate a cost difference for one or more candidate bully storage resource. In one embodiment, the candidate bully storage resources are ranked in decreasing order of cost increase. A given candidate bully storage resource with a positive cost difference (cost increase) is identified as a bully storage resource. In one embodiment, only bully block sizes represented in a block size presence set for the storage resource P_{sig}(s) are used in EQUATIONS 3-5; in other words, only blocks in ∀b∈P_{sig}(s)∩B^{rw} are used to compute the cost difference for the storage resource S.

The second diagnostic step is to identify a storage client bully (e.g., virtual machine bully). Identifying a storage client bully involves identifying which storage clients are generating traffic targeting an identified storage resource bully within the storage controller. When a particular storage client generates excessively costly workload for a storage resource within the storage controller, that storage client can be defined as a bully because the workload from the storage client can degrade performance for other workloads also accessing the storage controller. The techniques disclosed herein can be implemented to identify a particular storage client bully that causes a latency change event, given storage client workload statistics along with storage controller workload statistics. Furthermore, a sorted list of storage client bullies can be generated to indicate ranking among storage client bullies. These techniques are discussed in the context of method 500.

At step 510, the storage resource manager detects a latency change event for at least one block size. In one embodiment, detecting the latency change event includes measuring a latency that increases above a starting latency (Lstart) at time Tstart and measuring that the latency subsequently exceeds a significant latency threshold (Lsig) at time Tsig, as discussed with respect to FIG. 4. The latency change period for the detected latency change event is defined by a time interval between Tstart and Tsig.

At step 520, in response to detecting the latency change event, the storage resource manager records an IOPS value Istart sampled at the start time Tstart and an IOPS value Isig sampled at the significant threshold time Tsig for different write and read I/O request block sizes. The IOPS values recorded at Tsig and Tstart are used to calculate cost difference values for different block sizes to identify bully block sizes. The cost difference values are also used to calculate an overall cost difference for a given storage resource. In one embodiment, the storage resource manager records a block size presence set P_{sig} at time Tsig. The block size presence set and the bully block sizes are used to identify a bully (e.g., storage resource bully, virtual machine bully), as described herein.

At step 530, the storage resource manager generates a list of cost differences, each calculated according to EQUATION 5. In a first embodiment, the list includes a cost difference for various different storage resources within the storage controller. A cost difference for a given storage resource (S) is calculated as a sum of access type and block size cost differences for different access types (write/read) and block sizes (e.g., 4K . . . 2M). In one embodiment, only identified bully block sizes are included in calculating the cost difference. As calculated in EQUATIONS 3 and 4, each access type and block size cost difference in the sum operation of EQUATION 5 is calculated as a difference between two IOPS values (ΔI=Isig−Istart) multiplied by a relative cost (E_{rb}, E_{wb}) for block size b and access type (r for read, w for write).

In a second embodiment, the list of cost differences (e.g., calculated using only bully block sizes) includes cost differences for one or more different virtual machines configured to generate workloads targeting the storage controller, or a storage resource residing within the storage controller. A cost difference for a given virtual machine can be calculated according to EQUATIONS 3-5, using IOPS values recorded specifically for the virtual machine. In short, a cost difference for a given virtual machine is calculated as a sum of cost differences for different access types (write/read) and block sizes (e.g., 4K . . . 2M). In one embodiment, the block sizes include only bully block sizes. Each cost difference in the sum operation is calculated as a difference between two IOPS values (ΔI=Isig−Istart) for block type and size, multiplied by a corresponding cost E for the block size and type. In this second embodiment, the IOPS values for Isig and Istart are measured specifically with respect to the virtual machine.

In step 540, the list of cost differences is sorted to generate a sorted list of cost differences. In one embodiment, the list is sorted in decreasing order of cost difference, so that the first list entry is the largest cost difference (most expensive cost increase).

In a first embodiment, the sorted list of cost differences is generated for cost differences for storage resources residing on the storage controller. In a second embodiment, the sorted list of cost differences is generated for different virtual machines configured to access the storage controller (e.g., one or more storage resources residing on the storage controller).

In step 550, the storage resource manager selects a bully set of storage resources and/or virtual machines from the sorted list. In one embodiment, the bully set is selected to include a storage resource with the largest positive cost difference (storage resource bully). In another embodiment, the bully set is selected to include two or more storage resources with the largest positive cost differences. In yet another embodiment, the bully set is selected to include a virtual machine with the largest positive cost difference (virtual machine bully/storage client bully). In still yet another embodiment, the bully set is selected to include two or more virtual machines with the largest positive cost differences.

In one embodiment, a bully set can include one or more items as a consequence of latency rising above the significant latency threshold and the bully set being identified as described herein, even if none of the items are significantly more costly than other items. For example, if a number of virtual machines slowly increase their workload and cause a latency change event. Workload from the virtual machines can be approximately the same, but collectively, their workloads trigger a latency change event. As a consequence, traffic from one or more of the virtual machines may be identified for mitigation to ensure adequate performance of the other virtual machines. In a scenario with one virtual machine generating significantly more workload than others, that one virtual machine is selected for mitigation action.

At step 560, in response to selecting the bully set, the storage resource manager directs a mitigation action. In one embodiment, the storage resource manager directs a mitigation action that includes one of: activating cache system 110 of FIG. 1 to perform caching for one of more selected virtual machine bullies, activating rate limiting for one or more selected virtual machine bullies, migrating a storage resource such as a vDisk that is heavily accessed by a bully storage client, and migrating a storage resource bully. A mitigation action of caching can reduce workload by servicing some of the workload at a local cache that is close to a virtual machine bully. A mitigation action of rate limiting can directly reduce workload. A mitigation action of migrating a storage resource can indirectly reduce workload at a specific storage controller by shifting some of the workload to a different storage controller.

In summary, a latency increase above nominal latency for any different block size or access type in a storage controller can indicate an overload or interference condition and implicate storage resources and/or virtual machines as bullies. In various embodiments, detecting a latency increase triggers a diagnostic process that quantifies recent access costs to the storage controller with respect to one or more storage resources on the storage controller and/or virtual machines accessing the storage resources. In one embodiment, a storage resource or a storage client (e.g., a virtual machine) is identified as having introduced access requests of a new block size or caused a load increase for previously ongoing block sizes. Such a storage resource or storage client is identified as a potential bully. Upon identifying a storage resource bully or a virtual machine bully, an appropriate mitigation action can be performed.

The disclosed method and apparatus has been explained above with reference to several embodiments. Other embodiments will be apparent to those skilled in the art in light of this disclosure. Certain aspects of the described method and apparatus may readily be implemented using configurations other than those described in the embodiments above, or in conjunction with elements other than those described above. For example, different algorithms and/or logic circuits, perhaps more complex than those described herein, may be used.

Further, it should also be appreciated that the described method and apparatus can be implemented in numerous ways, including as a process, an apparatus, or a system. The methods described herein may be implemented by program instructions for instructing a processor to perform such methods, and such instructions recorded on a non-transitory computer readable storage medium such as a hard disk drive, floppy disk, optical disc such as a compact disc (CD) or digital versatile disc (DVD), flash memory, etc., or communicated over a computer network wherein the program instructions are sent over optical or electronic communication links. It should be noted that the order of the steps of the methods described herein may be altered and still be within the scope of the disclosure.

It is to be understood that the examples given are for illustrative purposes only and may be extended to other implementations and embodiments with different conventions and techniques. While a number of embodiments are described, there is no intent to limit the disclosure to the embodiment(s) disclosed herein. On the contrary, the intent is to cover all alternatives, modifications, and equivalents apparent to those familiar with the art.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

What is claimed is:

1. A method comprising:
detecting, by a storage resource manager, a latency change event for a first input/output (I/O) block size of read I/O requests or write I/O requests targeting storage resources residing within a storage controller, wherein detecting comprises:
measuring that a latency for a first block size of read I/O requests exceeds a nominal read latency for the first block size or a latency for the first block size of write I/O requests exceeds a nominal write latency for the first block size;
recording a first set of input/output operations per second (IOPS) values in response to the latency exceeding the nominal latency; and
measuring that the latency exceeds a significant latency threshold;
recording, by the storage resource manager, a block size presence set and a second set of IOPS values in response to detecting the latency change event, wherein the block size presence set is a count of requests for different read I/O request block sizes and write I/O request block sizes accumulated during a measurement time period;
generating, by the storage resource manager, a list of cost differences using the block size presence set, the first set of IOPS values, and the second set of IOPS values, wherein a cost difference for individual storage resources residing within the storage controller is calculated and added to the list of cost differences;
generating, by the storage resource manager, a sorted list of cost differences by sorting the list of cost differences in decreasing order of cost difference;
selecting, by the storage resource manager, a storage resource bully from the sorted list of cost differences;
directing, by the storage resource manager, a mitigation action in response to selecting the storage resource bully.

2. The method of claim 1, wherein the nominal read latency for the first block size is a saturation latency for read I/O requests for the first block size and the nominal write latency for the first block size is a saturation latency for write I/O requests for the first block size.

3. The method of claim 2, wherein the significant latency threshold is calculated as a multiple of the saturation latency for read I/O requests for the first block size or a multiple of the saturation latency for write I/O requests for the first block size.

4. The method of claim 1, wherein at least one of the storage resources is a storage logical unit number (LUN).

5. The method of claim 1, wherein the mitigation action is activating a system cache to cache data requests targeting the storage resource bully.

6. The method of claim 1, wherein the mitigation action is activating rate limiting on the storage resource bully.

7. The method of claim 1, wherein the mitigation action is migrating the storage resource bully from the storage controller to a destination storage controller.

8. The method of claim 1, wherein the cost difference for an individual storage resource is calculated as a sum of block size cost differences for read I/O requests for different read block sizes and block size cost differences for write I/O requests for different write block sizes.

9. The method of claim 8, wherein each block size cost difference for read I/O requests for the block size is calculated as a block size read cost for the block size multiplied by a read IOPS difference for the block size, and each block size cost difference for write I/O requests for the block size is calculated as a block size write cost for the block size multiplied by a write IOPS difference for the block size.

10. The method of claim 9, wherein the read IOPS difference for the block size is calculated by subtracting a read IOPS value from the first set of IOPS values from a corresponding read IOPS value from the second set of IOPS values, and wherein the write IOPS difference for the block size is calculated by subtracting a write IOPS value from the first set of IOPS values from a corresponding write IOPS value from the second set of IOPS values

11. The method of claim 1, wherein cost differences in the list of cost differences are calculated using only bully block sizes.

12. The method of claim 11, wherein a bully block size is a block size with a positive cost difference.

13. An apparatus, comprising:
a processing unit in communication with a storage controller, the processing unit configured to:
detect a latency change event for a first input/output (I/O) block size of read I/O requests or write I/O requests targeting storage resources residing within the storage controller, wherein to detect the latency change event, the processing unit is configured to:
measure that a latency for a first block size of read I/O requests exceeds a nominal read latency for the first block size or a latency for the first block size of write I/O requests exceeds a nominal write latency for the first block size;
record a first set of input/output operations per second (IOPS) values in response to the latency exceeding the nominal latency; and
measure that the latency exceeds a significant latency threshold;
record a block size presence set and a second set of IOPS values in response to detecting the latency change event, wherein the block size presence set is a count of requests for different read I/O request block sizes and write I/O request block sizes accumulated during a measurement time period;
generate a list of cost differences using the block size presence set, the first set of IOPS values, and the second set of IOPS values, wherein a cost difference for individual storage resources residing within the storage controller is calculated and added to the list of cost differences;
generate a sorted list of cost differences by sorting the list of cost differences in decreasing order of cost difference;
select a storage resource bully from the sorted list of cost differences;
direct a mitigation action in response to selecting the storage resource bully.

14. The apparatus of claim 13, wherein the nominal read latency for the first block size is a saturation latency for read I/O requests for the first block size and the nominal write latency for the first block size is a saturation latency for write I/O requests for the first block size, and wherein the significant latency threshold is calculated as a multiple of the saturation latency for read I/O requests for the first block size or a multiple of the saturation latency for write I/O requests for the first block size.

15. The apparatus of claim 13, wherein the mitigation action is one of activating a system cache to cache data requests targeting the storage resource bully, activating rate limiting on the storage resource bully, and migrating the storage resource bully from the storage controller to a destination storage controller.

16. The apparatus of claim 13, wherein cost differences in the list of cost differences are calculated using only bully block sizes, and wherein a bully block size is a block size with a positive cost difference.

17. A method comprising:
detecting, by a storage resource manager, a latency change event for a first input/output (I/O) block size of read I/O requests or write I/O requests targeting storage resources residing within a storage controller, wherein detecting comprises:
measuring that a latency for a first block size of read I/O requests exceeds a nominal read latency for the first block size or a latency for the first block size of write I/O requests exceeds a nominal write latency for the first block size;
recording a first set of input/output operations per second (IOPS) values in response to the latency exceeding the nominal latency; and
measuring that the latency exceeds a significant latency threshold;
recording, by the storage resource manager, a block size presence set and a second set of IOPS values in response to detecting the latency change event, wherein the block size presence set is a count of requests for different read I/O request block sizes and write I/O request block sizes accumulated during a measurement time period;
generating, by the storage resource manager, a list of cost differences using the block size presence set, the first set of IOPS values, and the second set of IOPS values, wherein a cost difference for individual storage resources residing within the storage controller is calculated and added to the list of cost differences;
generating, by the storage resource manager, a sorted list of cost differences by sorting the list of cost differences in decreasing order of cost difference;
selecting, by the storage resource manager, a storage client bully from the sorted list of cost differences; and
directing, by the storage resource manager, a mitigation action in response to selecting the storage client bully.

18. The method of claim 17, wherein cost differences in the list of cost differences are calculated using only bully block sizes, and wherein a bully block size is a block size with a positive cost difference

19. An apparatus, comprising:
a processing unit in communication with a storage controller, the processing unit configured to:
detect a latency change event for a first input/output (I/O) block size of read I/O requests or write I/O requests targeting storage resources residing within the storage controller, wherein to detect the latency change event, the processing unit is configured to:
measure that a latency for a first block size of read I/O requests exceeds a nominal read latency for the first block size or a latency for the first block size of write I/O requests exceeds a nominal write latency for the first block size;
record a first set of input/output operations per second (IOPS) values in response to the latency exceeding the nominal latency; and
measure that the latency exceeds a significant latency threshold;
record a block size presence set and a second set of IOPS values in response to detecting the latency change event, wherein the block size presence set is a count of requests for different read I/O request block sizes and write I/O request block sizes accumulated during a measurement time period;
generate a list of cost differences using the block size presence set, the first set of IOPS values, and the second set of IOPS values, wherein a cost difference for individual storage resources residing within the storage controller is calculated and added to the list of cost differences;
generate a sorted list of cost differences by sorting the list of cost differences in decreasing order of cost difference;
select a storage client bully from the sorted list of cost differences; and
direct a mitigation action in response to selecting the storage client bully.

20. The apparatus of claim 19, wherein cost differences in the list of cost differences are calculated using only bully block sizes, and wherein a bully block size is a block size with a positive cost difference.
